(19) United States
(12) Patent Application Publication
(10) Pub. No.: US 2026/0323326 A1
(43) Pub. Date: Oct. 15, 2026

(54) SENSING-BY-PROXY MEASUREMENT METHOD, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/104,173

(22) PCT Filed: Aug. 22, 2022
(86) PCT No.: PCT/CN2022/114015

§ 371 Date: Feb. 14, 2025

(51) Int. Cl. H04W 24/08; H04W 84/12

(52) U.S. Cl. CPC H04W 24/08; H04W 84/12

(57) ABSTRACT

A sensing-by-proxy (SBP) measurement method and related devices. The method, performed by an SBP initiator, includes determining a target radio frame comprising a first identification bit that specifies a sensing measurement type for an SBP procedure and transmitting the target radio frame to an SBP responder. The sensing measurement type may include null data packet announcement (NDPA) sounding, trigger frame (TF) sounding, or responder-to-responder (R2R) sensing, with configurable parameter values defining the measurement type or sounding sequence. The SBP responder receives the target radio frame, interprets the first identification bit, and executes the SBP procedure accordingly.

### CROSS-REFERENCE TO RELATED APPLICATION

The present application is a U.S. National Stage of International Application No. PCT/CN2022/114015, filed on Aug. 22, 2022, the contents of which are incorporated herein by reference in their entirety for all purposes.

### BACKGROUND OF THE INVENTION

With the rapid development of mobile communication technology, wireless fidelity (Wi-Fi) technology has made great progress in terms of transmission rate as well as throughput. Currently, research on the Wi-Fi technology includes 320 MHz bandwidth transmission, aggregation and cooperation of a plurality of frequency bands, and so on. The application scenarios of the Wi-Fi technology include video transmission, augmented reality (AR), and virtual reality (VR), and so on.

The aggregation and cooperation of a plurality of frequency bands refers to simultaneous communication between devices in 2.4 GHz, 5.8 GHz, 6 GHZ and other frequency bands. In the scenario of simultaneous communication between devices in a plurality of frequency bands, a new media access control (MAC) mechanism needs to be defined for management. Further, the aggregation and cooperation of a plurality of frequency bands is expected to be able to support low-latency transmission.

Currently, a maximum bandwidth to be supported in the aggregation and cooperation technology of a plurality of frequency bands is 320 MHz (160 MHz+160 MHz). In addition, 240 MHz (160 MHz+80 MHz) and other bandwidths supported by existing standards may also be supported possibly.

### SUMMARY OF THE INVENTION

Embodiments of the present disclosure relate to the field of mobile communications, and specifically, to a measurement method for sensing-by-proxy, an electronic device, and a storage medium.

According to one aspect of the embodiments of the present disclosure, a measurement method for sensing-by-proxy is provided. The measurement method for sensing-by-proxy is performed by a sensing-by-proxy (SBP) initiator. The method includes: determining a target radio frame, where the target radio frame includes a first identification bit, and the first identification bit identifies a sensing measurement type of an SBP procedure that the SBP initiator requests an SBP responder to initiate; and transmitting the target radio frame.

According to another aspect of the embodiments of the present disclosure, a measurement method for sensing-by-proxy is further provided. The measurement method for sensing-by-proxy is performed by a sensing-by-proxy (SBP) responder. The method includes: receiving a target radio frame, where the target radio frame includes a first identification bit, and the first identification bit identifies a sensing measurement type of an SBP procedure that an SBP initiator requests the SBP responder to initiate; and executing the SBP procedure according to the first identification bit.

According to another aspect of the embodiments of the present disclosure, an electronic device is further provided, which is a sensing-by-proxy (SBP) initiator. The electronic device includes: a determining module, configured to determine a target radio frame, where the target radio frame includes a first identification bit, and the first identification bit identifies a sensing measurement type of an SBP procedure that the SBP initiator requests an SBP responder to initiate; and a transmitting module, configured to transmit the target radio frame.

According to another aspect of the embodiments of the present disclosure, an electronic device is further provided, which is a sensing-by-proxy (SBP) responder. The electronic device includes: a receiving module, configured to receive a target radio frame, where the target radio frame includes a first identification bit, and the first identification bit identifies a sensing measurement type of an SBP procedure that an SBP initiator requests the SBP responder to initiate; and an execution module, configured to execute the SBP procedure according to the first identification bit.

According to the embodiments of the present disclosure, an electronic device is further provided, including a memory, a processor, and a computer program stored in the memory and runnable on the processor, where the processor, when executing the program, performs the method in one or more embodiments of the present disclosure.

According to the embodiments of the present disclosure, a non-transitory computer-readable storage medium is further provided, storing a computer program which, when executed by a processor, implements the method in one or more embodiments of the present disclosure.

### BRIEF DESCRIPTION OF DRAWINGS

To illustrate the technical solutions in the embodiments of the present disclosure more clearly, the following will briefly introduce the accompanying drawings needed to describe the embodiments of the present disclosure. It is clear that the accompanying drawings in the following description are merely some embodiments of the present disclosure, and those of ordinary skill in the art may further obtain other accompanying drawings from these accompanying drawings without creative efforts.

FIG. 1 is a first flowchart of a measurement method for sensing-by-proxy according to an embodiment of the present disclosure.

FIG. 2 is a first schematic diagram of a first instance according to an embodiment of the present disclosure.

FIG. 3 is a second schematic diagram of the first instance according to an embodiment of the present disclosure.

FIG. 4 is a third schematic diagram of the first instance according to an embodiment of the present disclosure.

FIG. 5 is a schematic diagram of a second instance according to an embodiment of the present disclosure.

FIG. 6 is a second flowchart of a measurement method for sensing-by-proxy according to an embodiment of the present disclosure.

FIG. 7 is a third flowchart of a measurement method for sensing-by-proxy according to an embodiment of the present disclosure.

FIG. 8 is a first schematic structural diagram of an electronic device according to an embodiment of the present disclosure.

FIG. 9 is a second schematic structural diagram of an electronic device according to an embodiment of the present disclosure.

FIG. 10 is a third schematic structural diagram of an electronic device according to an embodiment of the present disclosure.

### DETAILED DESCRIPTION OF THE INVENTION

The term “and/or” in embodiments of the present disclosure describes an association relationship between associated objects and represents that three relationships may exist. For example, A and/or B may represent the following three cases: only A exists, both A and B exist, and only B exists. The character “/” generally indicates an “or” relationship between the associated objects.

The term “a plurality of” in embodiments of the present disclosure refers to two or more, and other quantifier is similar to this.

Examples are illustrated in detail in the disclosure, with examples thereof shown in the accompanying drawings. When the following description involves the accompanying drawings, identical numbers in different accompanying drawings represent same or similar elements, unless otherwise specified. Implementations described in the following embodiments do not represent all implementations consistent with the present disclosure, and actually, are merely examples of the devices and methods consistent with some aspects of the present disclosure as detailed in the appended claims.

The terms used in the present disclosure are merely for the purpose of illustrating specific embodiments, and are not intended to limit the present disclosure. The terms “a,” “an” and “the” of singular forms used in the present disclosure and the appended claims are also intended to include plural forms, unless otherwise specified in the context clearly. It is also to be understood that the term “and/or” used in the disclosure indicates and includes any or all possible combinations of one or more associated listed items.

It is to be understood that although terms such as “first,” “second,” and “third” may be used in the present disclosure to describe pieces of information, these pieces of information should not be limited by these terms. These terms are merely used to distinguish between pieces of information of a same type. For example, without departing from the scope of the present disclosure, first information may also be referred to as second information. Similarly, second information may also be referred to as first information. Depending on the context, for example, the word “if” used in the disclosure may be explained as “while” or “when” or “in response to determining”.

The following clearly and completely describes the technical solutions in embodiments of the present disclosure with reference to the accompanying drawings in embodiments of the present disclosure. Apparently, the described embodiments are merely some but not all of embodiments of the present disclosure. All other embodiments obtained by those of ordinary skill in the art according to embodiments of the present disclosure without creative efforts shall fall within the scope of protection of the present disclosure.

In the current Wi-Fi technology in research, a wireless local area network (WLAN) sensing technology may be supported, such as location discovery, proximity detection, and presence detection in dense environments (such as home environment and corporate environment). During the WLAN Sensing, the identities of a station (STA) and an access point (AP) may be interchangeable. For example, both can act as an initiator device (a sensing initiator or a sensing transmitter). In a case of acting as a sensing initiator or a sensing transmitter, the AP can communicate with a plurality of STAs simultaneously. However, the STA does not have the above function and can only communicate one-to-one with a single responder (a sensing responder), which causes a waste of spectrum resources and an increase in delay and may not be able to satisfy the delay requirements for communication scenarios with high delay requirements. In order to solve these problems, a method of performing the WLAN sensing measurement with the AP as a proxy for the STA, that is, sensing by proxy (SBP), has been proposed. During the SBP procedure, there are many types of sensing measurement such as a null data packet announcement (NDPA) sounding, trigger frame (TF) sounding and responder to responder (R2R) sensing. Therefore, there is a need to provide a way of indicating a sensing measurement type of an SBP procedure to improve an SBP mechanism.

Embodiments of the present disclosure provide a measurement method for sensing-by-proxy, an electronic device, and a storage medium, so as to provide a way of indicating a sensing measurement type of an SBP procedure.

The method and the device are based on a same application concept. Since the method and the device have similar principles for resolving problems, reference may be made to each other for implementations of the device and the method. No repeated description is provided.

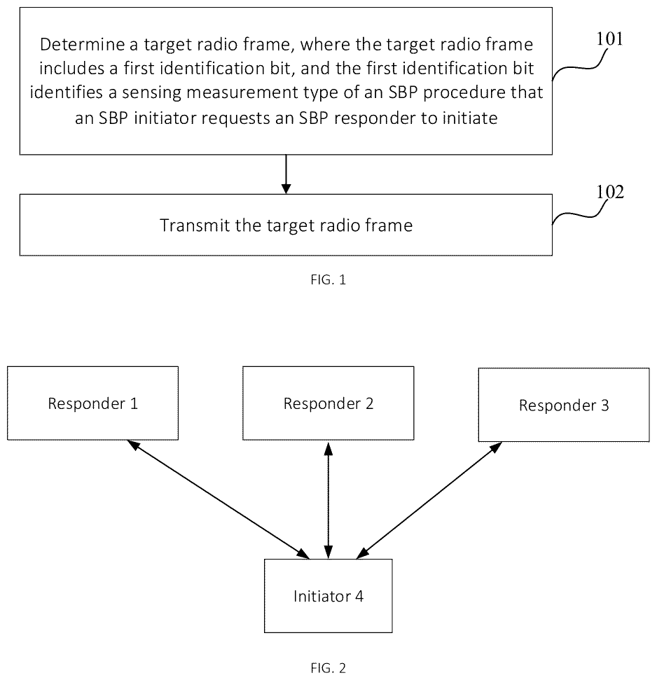

As shown in FIG. 1, an embodiment of the present disclosure provides a measurement method for sensing-by-proxy. In an example, the method may be performed by a sensing-by-proxy (SBP) initiator, such as a station (STA). The method may include steps 101 and 102.

Step 101 includes determining a target radio frame. The target radio frame includes a first identification bit. The first identification bit identifies a sensing measurement type of an SBP procedure that the SBP initiator requests an SBP responder to initiate.

As a first instance, referring to FIG. 2 to FIG. 4, an architecture of WLAN sensing and a procedure of the WLAN sensing to which the measurement method for sensing-by-proxy provided in an embodiment of the present disclosure is applied are first introduced.

FIG. 2 is a schematic diagram of an architecture of the WLAN sensing (procedure). A sensing initiator 4 (or an initiator) initiates the WLAN sensing (for example, initiates a WLAN sensing session). A plurality of sensing responders (or sensing receivers) or responders, such as responder 1, responder 2 and responder 3 shown in FIG. 2, may respond to the WLAN sensing. In a case that the sensing initiator 4 initiates the WLAN sensing, a plurality of associated or unassociated sensing responders may respond to the WLAN sensing.

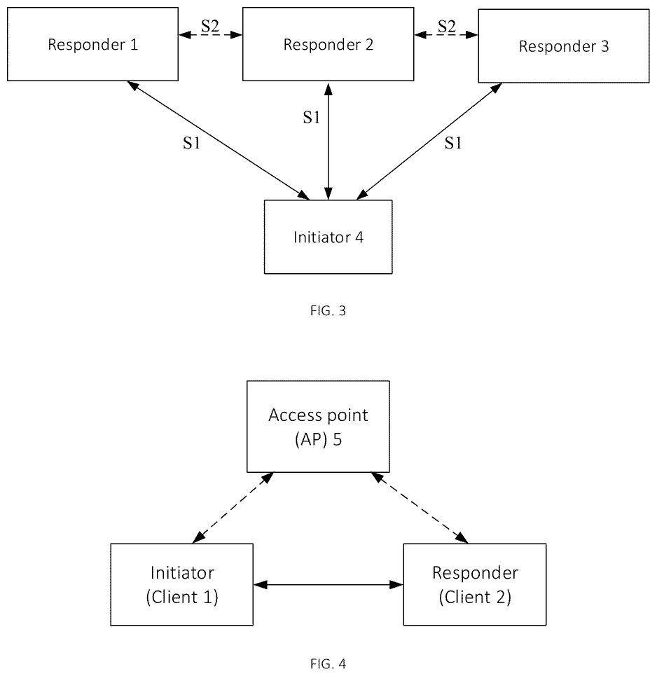

With reference to FIG. 3, the sensing initiator 4 communicates with the sensing responders 1, 2, 3 through communication connection, for example, communication connection S1. The sensing responders 1, 2, 3 communicate with each other through communication connection S2.

Each sensing initiator may be a client. Each sensing responder (i.e. the sensing responder 1 to the sensing responder 3 in this instance) may be a station (STA) or an access point (AP). In addition, the STA and the AP may play a plurality of roles in the procedure of the WLAN sensing. For example, in the procedure of the WLAN sensing, the STA may alternatively be a sensing initiator, and the sensing initiator may be a sensing transmitter, a sensing receiver, or both, or neither. In the procedure of the WLAN sensing, a sensing responder may also be a sensing transmitter, a sensing receiver, or both.

As another architecture, as shown in FIG. 4, both the sensing initiator and the sensing responder may be clients, and may communicate with each other by being connected to a same access point (AP) 5. In FIG. 4, client 1 is the sensing initiator, and Client 2 is the sensing responder.

Usually, when used as a sensing initiator or a sensing transmitter, the STA does not have a function of simultaneously communicating with a plurality of receivers. Therefore, a proxy device (such as the AP) is needed to serve as a proxy for the STA to perform sensing measurement, so as to improve the efficiency of sensing measurement.

In the SBP procedure, the sensing measurement type may be trigger-based (TB) sounding or R2R sensing measurement. Further, the TB sounding may include NDPA sounding and TF sounding. Therefore, the SBP initiator determines the target radio frame, the target radio frame includes an SBP request frame in an example, the first identification bit is included in the target radio frame, and the sensing measurement type of the SBP procedure that the SBP initiator requests the SBP responder to initiate is identified by the first identification bit, so that the SBP responder determines, according to the first identification bit, what type of sensing measurement establishment procedure to initiate.

In an example, in a case where the sensing measurement type includes two or one sensing measurement type, the first identification bit may perform identification by using one bit. For example, “0” represents the NDPA sounding, and “1” represents the TF sounding.

In a case where the sensing measurement type includes at least one of three sensing measurement types, the first identification bit may perform identification by using two bits. For example, “00” represents the R2R sensing measurement, “01” represents the NDPA sounding, “10” represents the TF sounding, and “11” represents the NDPA sounding and the TF sounding.

In addition, the sensing measurement type may alternatively be identified implicitly. For example, the sensing measurement type is identified by identifying identity information of the SBP responder. For example, identifying the identity information of the SBP responder as the sensing transmitter implicitly indicates that the SBP responder initiates establishment of the NDPA sounding. Alternatively, identifying the identity information of the SBP responder as the sensing receiver implicitly indicates that the SBP responder initiates the TF sounding. Alternatively, identifying the identity information of the SBP responder as the sensing receiver and the sensing transmitter implicitly indicates that two types of sensing measurement are initiated.

The identity information of the SBP responder may not be identified as the above two types. For example, neither identifying the identity information of the SBP responder as a sensing receiver nor identifying the identity information of the SBP responder as a sensing transmitter implicitly indicates that the SBP responder initiates establishment of R2R sensing measurement.

Step 102 includes transmitting the target radio frame.

The SBP initiator transmits the target radio frame to the SBP responder, so that the SBP responder determines, according to the first identification bit in the target radio frame, the sensing measurement type of the SBP procedure requested by the SBP initiator, and initiates the TB sensing measurement or the R2R sensing measurement according to the sensing measurement type.

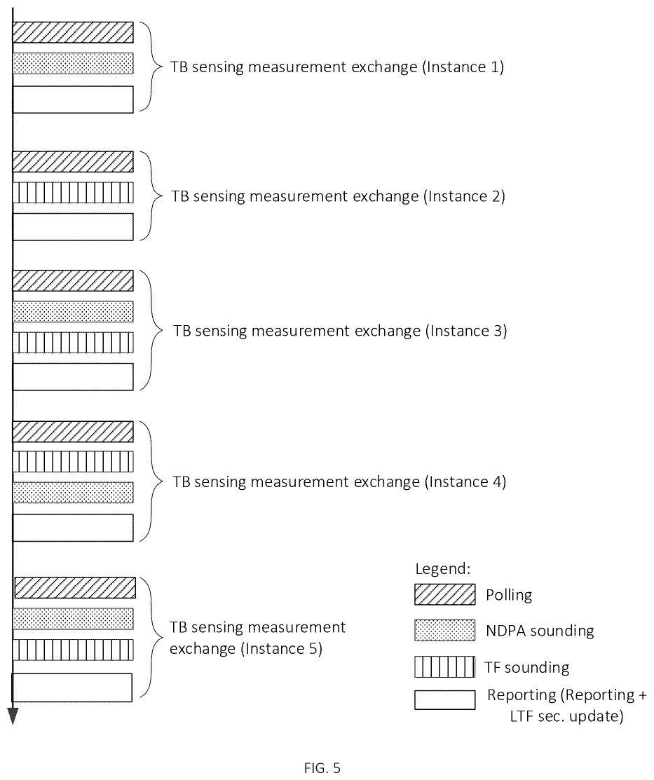

As a second instance, as shown in FIG. 5, the SBP responder serves as an SBP proxy and initiates TB sensing measurement, and the TB sensing measurement is divided into the NDPA sounding (downlink (DL), that is, transmitting an I2R NDP frame, where I2R means initiator to responder) sensing and trigger frame sounding (uplink (UL), that is, transmitting an R2I NDP frame, where R2I means responder to initiator) procedure.

FIG. 5 shows a plurality of sensing measurement exchanges under sensing measurement in a TB sensing measurement procedure. In instance 1 to 5, sensing measurement procedures all include polling, sounding, and reporting (Reporting+LTF sec. update). In each instance, sounding may include only the NDPA Sounding or the TF Sounding or may include both, and the SBP initiator may participate in the procedure of the NDPA sounding.

In the embodiments of the present disclosure, the SBP initiator determines the target radio frame, where the target radio frame includes the first identification bit, and the first identification bit identifies the sensing measurement type of the SBP procedure that the SBP initiator requests the SBP responder to initiate; and then the SBP initiator transmits the target radio frame, so that the SBP responder determines, according to the first identification bit in the target radio frame, the sensing measurement type of the SBP procedure requested by the SBP initiator, and initiates TB sensing measurement or R2R sensing measurement according to the sensing measurement type, improving an SBP sensing measurement mechanism. The embodiments of the present disclosure provide a way of indicating the sensing measurement type of the SBP procedure.

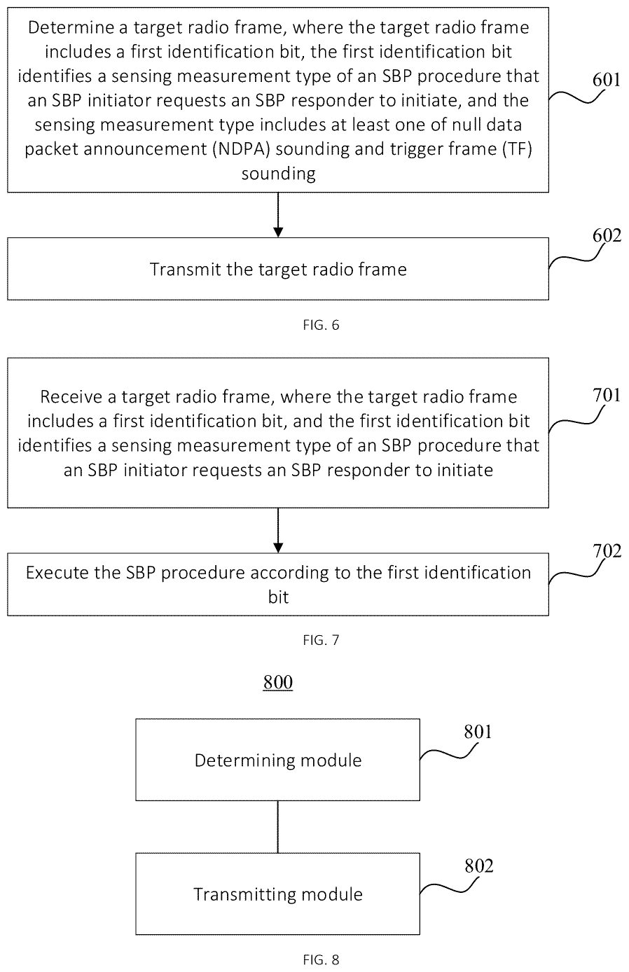

Referring to FIG. 6, an embodiment of the present disclosure provides a measurement method for sensing-by-proxy. In an example, the method may be performed by a sensing-by-proxy (SBP) initiator, such as a station. The method may include steps 601 and 602.

Step 601 includes determining a target radio frame. The target radio frame includes a first identification bit. The first identification bit identifies a sensing measurement type of an SBP procedure that the SBP initiator requests an SBP responder to initiate. The sensing measurement type includes at least one of null data packet announcement (NDPA) sounding and trigger frame (TF) sounding.

For an architecture of WLAN sensing and a procedure of the WLAN sensing to which the measurement method for sensing-by-proxy provided in an embodiment of the present disclosure is applied, reference is made to the first instance. Details are not described again.

The SBP responder (such as an AP) serves as a proxy for an STA to perform TB sensing measurement. Further, the TB sensing measurement includes the NDPA sounding and the TF sounding. Therefore, the SBP initiator determines the target radio frame, the first identification bit is included in the target radio frame, and the sensing measurement type of the TB sensing measurement that the SBP initiator requests the SBP responder to initiate is identified by the first identification bit, so that the SBP responder determines, according to the first identification bit, what type of sensing measurement establishment procedure to initiate.

In an example, in a case where the sensing measurement type includes one sensing measurement type, the first identification bit may perform identification by using one bit. For example, “0” represents the NDPA sounding, and “1” represents the TF sounding.

In a case where the sensing measurement type includes at least one of two sensing measurement types, the first identification bit may perform identification by using two bits. For example, “00” represents the NDPA sounding, “01” represents the TF sounding, and “10” represents the NDPA sounding and the TF sounding.

For a TB sensing measurement procedure, reference is made to the second instance. Details are not described again.

Step 602 includes transmitting the target radio frame.

The SBP initiator transmits the target radio frame to the SBP responder, so that the SBP responder determines, according to the first identification bit in the target radio frame, the sensing measurement type of the SBP procedure requested by the SBP initiator, and initiates at least one of the NDPA sounding or the TF sounding according to the sensing measurement type.

In an embodiment, in a case that the first identification bit is a first parameter value, the sensing measurement type includes the NDPA sounding; in a case that the first identification bit is a second parameter value, the sensing measurement type includes the TF sounding; in a case that the first identification bit is a third parameter value, the sensing measurement type includes the NDPA sounding and the TF sounding.

In a case where the sensing measurement type includes one sensing measurement type, the first identification bit may perform identification by using one bit. For example, the first parameter value is “0,” representing the NDPA sounding, and the second parameter value is “1,” representing the TF sounding.

In a case where the sensing measurement type includes at least one of two sensing measurement types, the first identification bit may perform identification by using two bits. For example, the first parameter value is “00,” representing the NDPA sounding, the second parameter value is “01,” representing the TF sounding, and the third parameter value is “10,” representing the NDPA sounding and the TF sounding.

An embodiment of the present disclosure provides a measurement method for sensing-by-proxy. In an example, the method may be performed by a sensing-by-proxy (SBP) initiator, such as a station. The method may include the following steps:
determining a target radio frame, where the target radio frame includes a first identification bit, and the first identification bit identifies a sensing measurement type of an SBP procedure that the SBP initiator requests an SBP responder to initiate; and in a case where the sensing measurement type includes the NDPA sounding and the TF sounding, the NDPA sounding and the TF sounding have a preset sounding sequence, alternatively, the target radio frame includes a second identification bit, and the second identification bit indicates a sounding sequence of the NDPA sounding and the TF sounding; and
transmitting the target radio frame.

In a case where the sensing measurement type includes the NDPA sounding and the TF sounding, there are two cases of the sounding sequence of the NDPA sounding and the TF sounding.

Case 1: The NDPA sounding and the TF sounding have a fixed sounding sequence. For example, NDPA sounding occurs first, followed by TF sounding, or the TF sounding occurs first, followed by the NDPA sounding.

Case 2: A second identification bit is added to the target radio frame, and the second identification bit indicates the sounding sequence of the NDPA sounding and the TF sounding. For example, “0” indicates that the NDPA sounding occurs first, followed by the TF sounding, and “1” indicates that the TF sounding occurs first, followed by the NDPA sounding.

An embodiment of the present disclosure provides a measurement method for sensing-by-proxy. In an example, the method may be performed by a sensing-by-proxy (SBP) initiator, such as a station. The method may include the following steps:
determining a target radio frame, where the target radio frame includes a first identification bit, and the first identification bit identifies a sensing measurement type of an SBP procedure that the SBP initiator requests an SBP responder to initiate; and in a case where the sensing measurement type includes the NDPA sounding and the TF sounding, the NDPA sounding and the TF sounding have the same or different sensing measurement request parameters; and
transmitting the target radio frame.

There may be different sensing measurement parameters for communication parameters of the two types of sensing measurement. For example, parameters such as number of spatial streams (NSS) and bandwidth (BW) may not be completely the same, that is, different types of sensing measurement may correspond to different sensing measurement parameters. In addition, various communication parameters of the sensing measurements may be set to be the same or different.

An embodiment of the present disclosure provides a measurement method for sensing-by-proxy. In an example, the method may be performed by a sensing-by-proxy (SBP) initiator, such as a station. The method may include the following steps:
determining a target radio frame, where the target radio frame includes a first identification bit, and the first identification bit identifies a sensing measurement type of an SBP procedure that the SBP initiator requests an SBP responder to initiate; and the sensing measurement type includes responder to responder (R2R) sensing measurement; and
transmitting the target radio frame.

The R2R sensing measurement is triggered by the SBP responder (an AP). During the R2R sensing measurement, one STA serves as a sensing transmitter, and other STAs serve as a sensing receiver. In an embodiment of the present disclosure, the sensing measurement type that the SBP initiator requests the AP to initiate may be the R2R sensing measurement.

In the embodiments of the present disclosure, the SBP initiator determines the target radio frame, where the target radio frame includes the first identification bit, and the first identification bit identifies the sensing measurement type of the SBP procedure that the SBP initiator requests the SBP responder to initiate; and then the SBP initiator transmits the target radio frame, so that the SBP responder determines, according to the first identification bit in the target radio frame, the sensing measurement type of the SBP procedure requested by the SBP initiator, and initiates TB sensing measurement or R2R sensing measurement according to the sensing measurement type, improving an SBP sensing measurement mechanism.

Referring to FIG. 7, an embodiment of the present disclosure provides a measurement method for sensing-by-proxy. In an example, the method may be performed by a sensing-by-proxy (SBP) responder, such as an access point. The method may include steps 701 and 702.

Step 701 includes receiving a target radio frame. The target radio frame includes a first identification bit. The first identification bit identifies a sensing measurement type of an SBP procedure that an SBP initiator requests the SBP responder to initiate.

For an architecture of WLAN sensing and a procedure of the WLAN sensing to which the measurement method for sensing-by-proxy provided in embodiments of the present disclosure is applied, reference is made to the first instance. Details are not described again.

Usually, when used as a sensing initiator or a sensing transmitter, an STA does not have a function of simultaneously communicating with a plurality of receivers. Therefore, a proxy device (such as an AP) is needed to serve as a proxy for the STA to perform sensing measurement, so as to improve efficiency of the sensing measurement.

In the SBP procedure, the sensing measurement type may be trigger-based (TB) sounding or R2R sensing measurement. Further, the TB sounding includes NDPA sounding and TF sounding. Therefore, the SBP responder receives the target radio frame, the target radio frame includes an SBP request frame in an example, the first identification bit is included in the target radio frame, and the sensing measurement type of the SBP procedure that the SBP initiator requests the SBP responder to initiate is identified by the first identification bit, so that the SBP responder determines, according to the first identification bit, what type of sensing measurement establishment procedure to initiate.

In an example, in a case where the sensing measurement type includes two or one sensing measurement type, the first identification bit may perform identification by using one bit. For example, “0” represents the NDPA sounding, and “1” represents the TF sounding.

In a case where the sensing measurement type includes at least one of three sensing measurement types, the first identification bit may perform identification by using two bits. For example, “00” represents the R2R sensing measurement, “01” represents the NDPA sounding, “10” represents the TF sounding, and “11” represents the NDPA sounding and the TF sounding.

For a TB sensing measurement procedure, reference is made to the second instance. Details are not described again.

In an example, in a case where the sensing measurement type includes the NDPA sounding and the TF sounding, the target radio frame further includes a second identification bit, and the second identification bit indicates a sounding sequence of the NDPA sounding and the TF sounding. There are two cases of the sounding sequence of the NDPA sounding and the TF sounding.

Case 1: The NDPA sounding and the TF sounding have a fixed sounding sequence. For example, NDPA sounding occurs first, followed by TF sounding, or the TF sounding occurs first, followed by the NDPA sounding.

Case 2: A second identification bit is added to the target radio frame, and the second identification bit indicates the sounding sequence of the NDPA sounding and the TF sounding. For example, “0” indicates that the NDPA sounding occurs first, followed by the TF sounding, and “1” indicates that the TF sounding occurs first, followed by the NDPA sounding.

Step 702 includes executing the SBP procedure according to the first identification bit.

The SBP responder determines, according to the first identification bit in the target radio frame, the sensing measurement type of the SBP procedure requested by the SBP initiator, and initiates the TB sensing measurement or the R2R sensing measurement according to the sensing measurement type.

In the embodiments of the present disclosure, the SBP responder receives the target radio frame, where the target radio frame includes the first identification bit, and the first identification bit identifies the sensing measurement type of the SBP procedure that the SBP initiator requests the SBP responder to initiate; and then the SBP responder determines, according to the first identification bit in the target radio frame, the sensing measurement type of the SBP procedure requested by the SBP initiator, and initiates TB sensing measurement or R2R sensing measurement according to the sensing measurement type, improving an SBP sensing measurement mechanism.

Referring to FIG. 8, based on a principle the same as that of the method provided in the embodiments of the present disclosure, an embodiment of the present disclosure further provides an electronic device, which is a sensing-by-proxy (SBP) initiator. The electronic device 800 includes: a determining module 801, configured to determine a target radio frame, where the target radio frame includes a first identification bit, and the first identification bit identifies a sensing measurement type of an SBP procedure that the SBP initiator requests an SBP responder to initiate; and a transmitting module 802, configured to transmit the target radio frame.

In an embodiment, the sensing measurement type includes at least one of null data packet announcement (NDPA) sounding and trigger frame (TF) sounding.

In an embodiment, in a case that the first identification bit is a first parameter value, the sensing measurement type includes the NDPA sounding; in a case that the first identification bit is a second parameter value, the sensing measurement type includes the TF sounding; in a case that the first identification bit is a third parameter value, the sensing measurement type includes the NDPA sounding and the TF sounding.

In an embodiment, in a case where the sensing measurement type includes the NDPA sounding and the TF sounding, the NDPA sounding and the TF sounding have a preset sounding sequence; or the target radio frame includes a second identification bit, and the second identification bit indicates a sounding sequence of the NDPA sounding and the TF sounding.

In an embodiment, in a case where the sensing measurement type includes the NDPA sounding and the TF sounding, the NDPA sounding and the TF sounding have the same or different sensing measurement request parameters.

In an embodiment, the sensing measurement type includes responder to responder (R2R) sensing measurement.

In an embodiment, the target radio frame includes an SBP request frame.

In the embodiments of the present disclosure, the determining module 801 determines the target radio frame, where the target radio frame includes the first identification bit, and the first identification bit identifies the sensing measurement type of the SBP procedure that the SBP initiator requests the SBP responder to initiate; and the transmitting module 802 transmits the target radio frame, so that the SBP responder determines, according to the first identification bit in the target radio frame, the sensing measurement type of the SBP procedure requested by the SBP initiator, and initiates TB sensing measurement or R2R sensing measurement according to the sensing measurement type, improving an SBP sensing measurement mechanism.

An embodiment of the present disclosure further provides a measurement device for sensing-by-proxy, applied to a sensing-by-proxy (SBP) initiator. The device (not shown) includes:
a radio frame determining module (not shown), configured to determine a target radio frame, where the target radio frame includes a first identification bit, and the first identification bit identifies a sensing measurement type of an SBP procedure that the SBP initiator requests an SBP responder to initiate; and
a radio frame transmitting module (not shown), configured to transmit the target radio frame.

The device further includes other modules of the electronic device in the embodiments of the disclosure. Details are not described again.

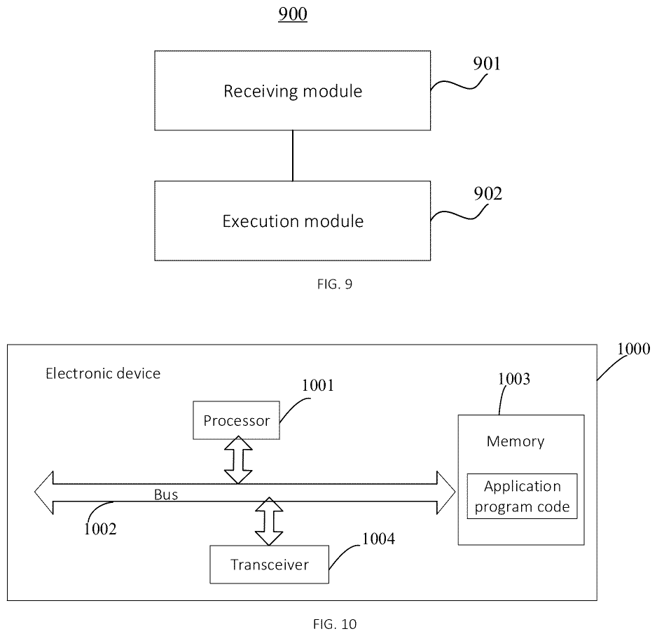

Referring to FIG. 9, based on a principle the same as that of the method provided in the embodiments of the present disclosure, an embodiment of the present disclosure further provides an electronic device, which is a sensing-by-proxy (SBP) responder. The electronic device 900 includes: a receiving module 901, configured to receive a target radio frame, where the target radio frame includes a first identification bit, and the first identification bit identifies a sensing measurement type of an SBP procedure that an SBP initiator requests the SBP responder to initiate; and an execution module 902, configured to execute the SBP procedure according to the first identification bit.

In the embodiment of the present disclosure, the receiving module 901 receives the target radio frame, where the target radio frame includes the first identification bit, and the first identification bit identifies the sensing measurement type of the SBP procedure that the SBP initiator requests the SBP responder to initiate; and the execution module 902 determines, according to the first identification bit in the target radio frame, the sensing measurement type of the SBP procedure requested by the SBP initiator, and initiates TB sensing measurement or R2R sensing measurement according to the sensing measurement type, improving an SBP sensing measurement mechanism.

An embodiment of the present disclosure further provides a measurement device for sensing-by-proxy, applied to a sensing-by-proxy (SBP) responder. The device (not shown) includes: a radio frame receiving module (not shown), configured to receive a target radio frame, where the target radio frame includes a first identification bit, and the first identification bit identifies a sensing measurement type of an SBP procedure that an SBP initiator requests the SBP responder to initiate; and an SBP execution module (not shown), configured to execute the SBP procedure according to the first identification bit.

The device further includes other modules of the electronic device in the embodiments of the disclosure. Details are not described again.

In an embodiment, the embodiment of the present disclosure further provides an electronic device as shown in FIG. 10. The electronic device 1000 shown in FIG. 10 may be a server and include a processor 1001 and a memory 1003. The processor 1001 is connected to the memory 1003, for example, through a bus 1002. In an example, the electronic device 1000 may further include a transceiver 1004. It is to be noted that a quantity of transceivers 1004 in an actual application is not limited to one, and the structure of the electronic device 1000 does not constitute any limitation on the embodiments of the present disclosure.

The processor 1001 may be a central processing unit (CPU), a general-purpose processor, a digital signal processor (DSP), an application specific integrated circuit (ASIC), a field programmable gate array (FPGA) or other programmable logic device, transistor logic device, hardware component, or any combination thereof. The processor 1001 may implement or execute various logical blocks, modules, and circuits described with reference to content disclosed in the present disclosure. Alternatively, the processor 1001 may be a combination of processors implementing a computing function, such as a combination including one or more microprocessors, or a combination of a DSP and a microprocessor.

The bus 1002 may include a path for transmitting information between the foregoing components. The bus 1002 may be a peripheral component interconnect (PCI) bus, an extended industry standard architecture (EISA) bus, or the like. The bus 1002 may be classified into an address bus, a data bus, a control bus, and the like. For ease of representation, only one thick line is used to represent the bus in FIG. 10, but this does not mean that there is only one bus or only one type of bus.

The memory 1003 may be a read only memory (ROM), or other type of static storage device that can store static information and instructions, a random access memory (RAM) or other type of dynamic storage device that can store information and instructions, or may be an electrically erasable programmable read only memory (EEPROM), a compact disc read only memory (CD-ROM), or other compact disc storage, optical disc storage (including a compressed optical disc, a laser disc, an optical disc, a digital versatile optical disc, a Blu-ray disc, and the like), a magnetic disk storage medium, or other magnetic storage device, or any other medium that can be used to carry or store desired program code in the form of instructions or a data structure and that can be accessed by a computer, but is not limited thereto.

The memory 1003 is configured to store application program code for executing the solutions in the present disclosure, and the processor 1001 controls execution. The processor 1001 is configured to execute the application program code stored in the memory 1003 to implement the content shown in the method embodiments.

The electronic device 1000 includes, but is not limited to, a mobile terminal such as a mobile phone, a notebook computer, a digital broadcast receiver, a Personal Digital Assistant (PDA), a PAD, a Portable Multimedia Player (PMP), and a vehicle-mounted terminal (e.g., a vehicle-mounted navigation terminal), and a fixed terminal such as a digital TV and a desktop computer. The electronic device 1000 shown in FIG. 10 is merely an example, and should not constitute any limitation on the functions and the scope of use of the embodiments of the present disclosure.

The server provided in the present disclosure may be an independent physical server, a server cluster or distributed system including a plurality of physical servers, or a cloud server that provides basic cloud computing services such as cloud services, cloud databases, cloud computing, cloud functions, cloud storage, network services, cloud communication, middleware services, domain name services, security services, content distribution network (CDN), big data, and artificial intelligence platforms. The terminal may be a smartphone, a pad, a notebook computer, a desktop computer, a smart speaker, a smart watch, or the like, but is not limited thereto. The terminal and the server may be directly or indirectly connected in a wired or wireless communication manner, which is not limited in the present disclosure.

An embodiment of the present disclosure provides a non-transitory computer-readable storage medium storing a computer program thereon. The computer program, when running on a computer, cause the computer to execute corresponding content in the method embodiments.

It is to be understood that although various steps in the flowcharts of the accompanying drawings are shown sequentially as indicated by arrows, these steps are not necessarily performed sequentially in a sequence indicated by the arrows. Unless explicitly stated, there is no strict limitation on the execution sequence of these steps, and these steps may be performed in another sequence. In addition, at least some of the steps in the flowcharts of the accompanying drawings may include a plurality of sub-steps or stages, and these sub-steps or stages are not necessarily completed at the same time, but may be executed at different times, and are not necessarily performed sequentially, but may be executed in turn or alternately with other steps or at least some of sub-steps or stages of other steps.

It needs to be noted that the non-transitory computer-readable medium in the present disclosure may be a computer-readable signal medium or a non-transitory computer-readable storage medium or a combination thereof. The non-transitory computer-readable storage medium may be, for example, but is not limited to, an electrical, magnetic, optical, electromagnetic, infrared, or semiconductor system, device, or component, or any combination thereof. A more specific example of the non-transitory computer-readable storage medium may include, but is not limited to, an electrical connection having one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination thereof. In the present disclosure, the non-transitory computer-readable storage medium may be any tangible medium that includes or stores a program, and the program may be used by or in combination with an instruction execution system, apparatus, or device. In the present disclosure, the computer-readable signal medium may be included in a baseband or be used as a data signal propagated as a part of a carrier, where the data signal carries computer-readable program code. The data signal propagated in this manner may be in a plurality of forms, including but not limited to an electromagnetic signal, an optical signal, or any suitable combination thereof. The computer-readable signal medium may alternatively be any computer-readable medium other than the non-transitory computer-readable storage medium. The computer-readable signal medium may send, propagate, or transmit the program used by or in combination with the instruction execution system, apparatus, or device. Program code included in the computer-readable medium may be transmitted by using any suitable medium, including but not limited to an electric wire, an optical cable, radio frequency (RF), or any suitable combination thereof.

The computer-readable medium may be included in the electronic device, or may exist alone without being assembled into the electronic device.

The computer-readable medium carries one or more programs. When the one or more programs are executed by the electronic device, the electronic device executes the method shown in the embodiments of the disclosure.

According to one aspect of the present disclosure, a computer program product or computer program is provided. The computer program product or the computer program includes computer instructions stored in a non-transitory computer-readable storage medium. A processor of a computer device reads the computer instructions from the non-transitory computer-readable storage medium, and the processor executes the computer instructions, so that the computer device performs methods provided in various implementations.

Computer program code for performing operations in the present disclosure may be written in one or more programming languages, or a combination thereof. The programming languages include an object-oriented programming language, such as Java, Smalltalk, and C++, and also include a conventional procedural programming language, such as a “C” language or a similar programming language. The program code may be executed entirely on a user computer, partly on a user computer, as a separate software package, partly on a user computer and partly on a remote computer, or entirely on a remote computer or a server. When involved, a remote computer may be connected to a user computer through any type of network, including a local area network (LAN) or a wide area network (WAN), or may be connected to an external computer (e.g., connected to the external computer by using an Internet service provider through the Internet).

The flowcharts and block diagrams in the accompanying drawings show possible implementations of system architectures, functions, and operations of systems, methods, and computer program products according to various embodiments of the present disclosure. In this regard, each block in the flowcharts or block diagrams may represent a module, a program segment, or a part of code, and the module, the program segment, or the part of the code includes one or more executable instructions for implementing a specified logical function. It is also to be noted that in some alternative implementations, functions marked in the blocks may alternatively occur in a sequence different from that marked in the accompanying drawings. For example, two consecutive blocks may actually be executed substantially in parallel, and may sometimes be executed in a reverse sequence, depending on the functions involved. It is also to be noted that each block in the block diagrams and/or the flowcharts, and a combination of blocks in the block diagram and/or the flowchart may be implemented by a dedicated hardware-based system that performs specified functions or operations, or may be implemented by a combination of dedicated hardware and computer instructions.

The modules described in the embodiments of the present disclosure may be implemented in software or hardware. A name of the module does not constitute any limitation on the module in some cases. For example, a module A may alternatively be described as “the module A for performing an operation B”.

The foregoing description is merely embodiments of the present disclosure and an illustration of the applied technical principles. A person skilled in the art should understand that the scope of the present disclosure is not limited to a technical solution formed by a specific combination of the above technical features, and other technical solutions formed by any combination of the above technical features or equivalent features thereof without departing from the concept of the present disclosure shall fall within the scope of the present disclosure, for example, a technical solution formed by replacing the above features with technical features having similar functions disclosed in the present disclosure (but not limited to).

1. A measurement method for sensing-by-proxy, performed by a sensing-by-proxy (SBP) initiator, the method comprising:
determining a target radio frame, wherein the target radio frame comprises a first identification bit, and the first identification bit identifies a sensing measurement type of an SBP procedure that the SBP initiator requests an SBP responder to initiate; and
transmitting the target radio frame.

2. The measurement method for sensing-by-proxy according to claim 1, wherein the sensing measurement type comprises at least one of null data packet announcement (NDPA) sounding and trigger frame (TF) sounding.

3. The measurement method for sensing-by-proxy according to claim 2, wherein,
in a case that the first identification bit is a first parameter value, the sensing measurement type comprises the NDPA sounding;
in a case that the first identification bit is a second parameter value, the sensing measurement type comprises the TF sounding;
in a case that the first identification bit is a third parameter value, the sensing measurement type comprises the NDPA sounding and the TF sounding.

4. The measurement method for sensing-by-proxy according to claim 2, wherein in a case that the sensing measurement type comprises the NDPA sounding and the TF sounding,
the NDPA sounding and the TF sounding have a preset sounding sequence; or
the target radio frame comprises a second identification bit, and the second identification bit indicates a sounding sequence of the NDPA sounding and the TF sounding.

5. The measurement method for sensing-by-proxy according to claim 1, wherein the sensing measurement type comprises responder to responder (R2R) sensing measurement.

6. The measurement method for sensing-by-proxy according to claim 1, wherein the target radio frame comprises an SBP request frame.

7. A measurement method for sensing-by-proxy, performed by a sensing-by-proxy (SBP) responder, the method comprising:
receiving a target radio frame, wherein the target radio frame comprises a first identification bit, and the first identification bit identifies a sensing measurement type of an SBP procedure that an SBP initiator requests the SBP responder to initiate; and
executing the SBP procedure according to the first identification bit.

8. (canceled)

9. (canceled)

10. An electronic device, applied to a sensing-by-proxy (SBP) initiator, comprising:
a memory that stores a computer program; and
one or more processors communicatively coupled to the memory,
wherein the computer program, when collectively executed by the one or more processors, causes the electronic device to:
determine a target radio frame, wherein the target radio frame comprises a first identification bit, and the first identification bit identifies a sensing measurement type of an SBP procedure that the SBP initiator requests an SBP responder to initiate; and
transmit the target radio frame.

11. A non-transitory computer-readable storage medium, storing a computer program which, when executed by a processor of the sensing-by-proxy (SBP) initiator, causes the SBP initiator to perform the method according to claim 7.

12. The electronic device according to claim 10, wherein the sensing measurement type comprises at least one of null data packet announcement (NDPA) sounding and trigger frame (TF) sounding.

13. The electronic device according to claim 12, wherein,
in a case that the first identification bit is a first parameter value, the sensing measurement type comprises the NDPA sounding;
in a case that the first identification bit is a second parameter value, the sensing measurement type comprises the TF sounding;
in a case that the first identification bit is a third parameter value, the sensing measurement type comprises the NDPA sounding and the TF sounding.

14. The electronic device according to claim 12, wherein in a case that the sensing measurement type comprises the NDPA sounding and the TF sounding,
the NDPA sounding and the TF sounding have a preset sounding sequence; or
the target radio frame comprises a second identification bit, and the second identification bit indicates a sounding sequence of the NDPA sounding and the TF sounding.

15. The electronic device according to claim 10, wherein the sensing measurement type comprises responder to responder (R2R) sensing measurement.

16. The electronic device according to claim 10, wherein the target radio frame comprises an SBP request frame.

17. An electronic device, comprising:
a memory that stores computer program; and
one or more processors communicatively coupled to the memory,
wherein the computer program when collectively executed by the one or more processors cause the electronic device to act as a sensing-by-proxy (SBP) responder and perform the method according to claim 7.

18. A non-transitory computer-readable storage medium, storing a computer program which, when executed by a processor of a sensing-by-proxy (SBP) responder, causes the SBP responder to perform the method according to claim 7.
